(19) United States
(12) Patent Application Publication
(10) Pub. No.: US 2006/0039104 A1
(43) Pub. Date: Feb. 23, 2006

(54) Notebook computer with adjustable monitor

(75) Inventors: Chen-Yu Wang, Taipei Shien (TW); Jung-Wen Chang, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/135,202

(22) Filed: May 23, 2005

(30) Foreign Application Priority Data
Aug. 17, 2004 (TW) 93124632

(51) Int. Cl. G06F 1/16

(52) U.S. Cl. 361/681; 248/917

(57) ABSTRACT

The invention provides a notebook computer with a adjustable monitor. The notebook computer includes a host, a monitor, and a connecting device connecting the host and the monitor. The connecting device functions allows the monitor to be positioned freely with respect to the host. The display can, accordingly, be viewed at a proper distance with a comfortable visual angle in different environments.

### BACKGROUND

The present invention relates in general to a notebook computer and in particular to a notebook computer with an adjustable monitor.

Referring to FIG. 1, a conventional notebook computer 1 comprises a host 11 and a monitor 12, which are connected by a hinge 10, defining open and closed positions thereof. In different environments, user usually needs to adjust the height and the distance of the monitor 12 to match the requirements for comfortable using. For example, some items may be placed under the host 11 of the notebook computer 1 to achieve a suitable viewing angle. However, the prior adjustable method for the notebook computer 1 is very limited and user discomfort still often results.

### SUMMARY

Accordingly, embodiments of the invention provide a notebook computer with a adjustable monitor comprising a host, a monitor and a connecting device. The host provides a power source. The monitor is connected electrically to the host. The connecting device, with one end hinging on the host and the other end hinging on the monitor, allows the monitor to be positioned freely with respect to the host.

### BRIEF DESCRIPTION OF THE DRAWINGS

The present invention can be more fully understood by reading the subsequent detailed description and examples with references made to the accompanying drawings, wherein:

FIG. 1 is a schematic structure of a conventional notebook computer;

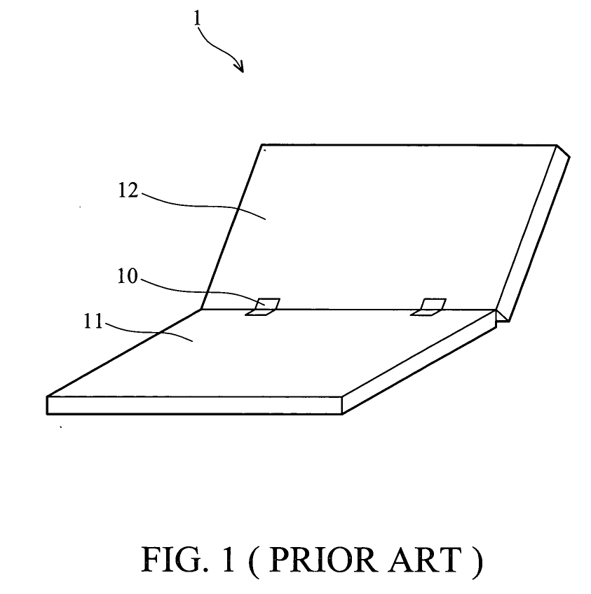

FIG. 2A shows an embodiment in which a monitor is open and adjustable backward by a connecting device;

FIG. 2B shows an embodiment in which a monitor is open and adjustable forward by a connecting device;

FIG. 3A shows another embodiment in which a monitor is open and adjustable backward by a connecting device;

FIG. 3B shows another embodiment in which a monitor is open and adjustable forward by a connecting device;

FIG. 4A shows yet another embodiment in which a monitor is open and adjustable upward by a connecting device;

FIG. 4B shows yet another embodiment in which a monitor is open and adjustable forward by a connecting device; and

FIG. 5 is a side view of a connecting device.

### DETAILED DESCRIPTION

### An Embodiment

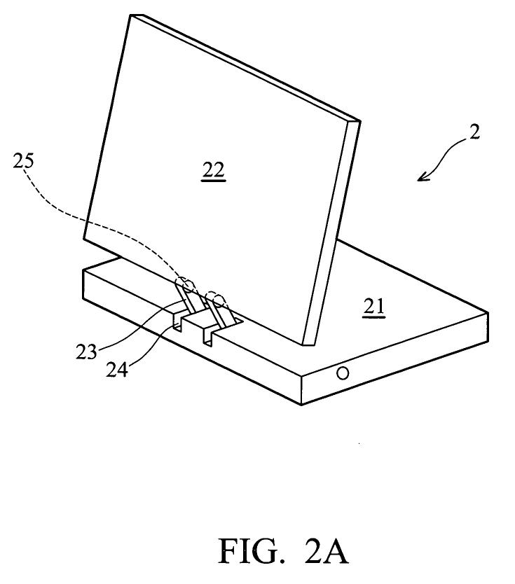

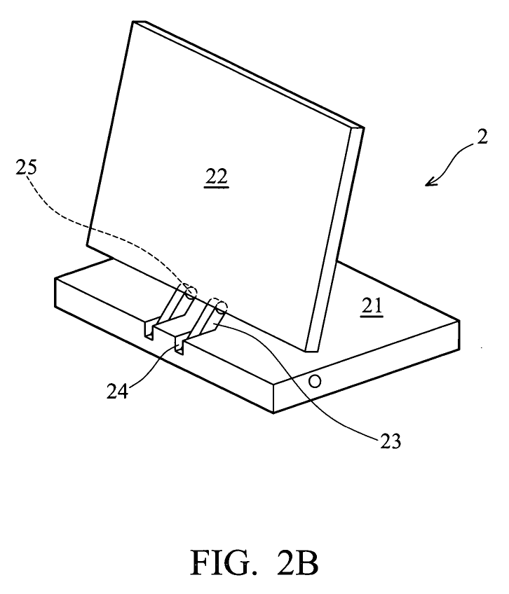

Referring to FIGS. 2A and 2B, the notebook computer 2 comprises a host 21 providing power, a monitor 22 displaying data, and a connecting device 23 connecting between the host 21 and the monitor 22. The connecting device 23, supporting the monitor 22 is installed in hollow 24, situated on the host 21, and adjustable upward, downward, forward and backward. The host 21 connects to the monitor 22 indirectly via the connecting device 23. When the monitor 22 is closed, the hollow 24 holds the whole connecting device 23. The connecting device 23 in the embodiment is a rocker arm, with one end hinging on the monitor 22 and the other end hinging on the host 21, allowing wider adjustment of the monitor than a conventional monitor.

### Another Embodiment

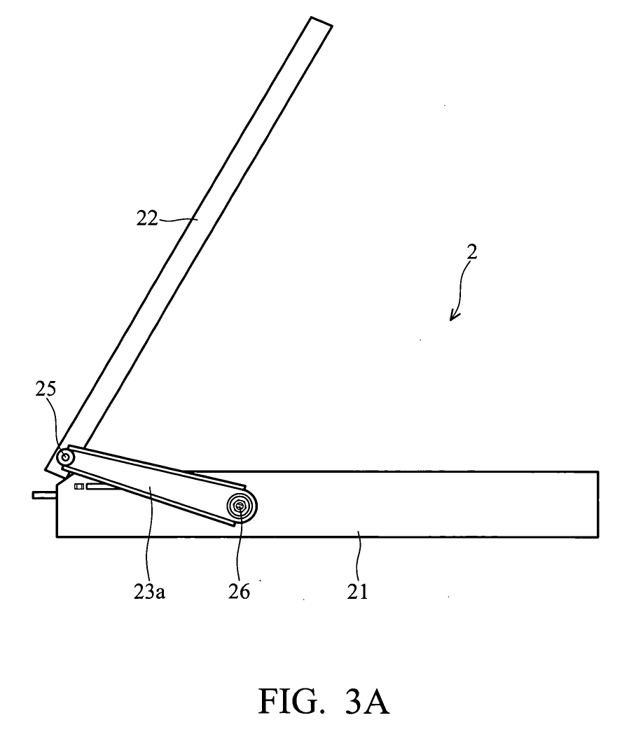

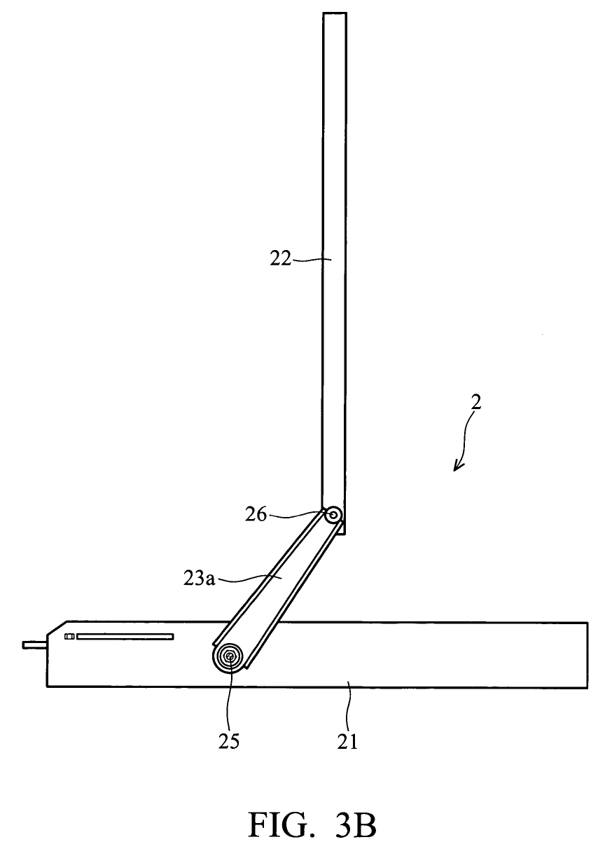

Referring to FIGS. 3A and 3B, the connecting device 23a is installed on the sides of the host 21 and the monitor 22. The sides of the host installed with the connecting device 23a is perpendicular to a side of the host 21 corresponding to the monitor 22. The sides of the monitor 22 installed with the connecting device 23a is perpendicular to a side of the monitor 22 corresponding to the host 21. In the embodiment, hollow 24 of FIG. 2A is unnecessary. Two ends of the connecting device 23a are connected to the host 21 and the monitor 22 via hinges. The connecting device 23a functions allow the monitor to be movable upward, downward, forward and backward with respect to the host 21.

### Yet Another Embodiment

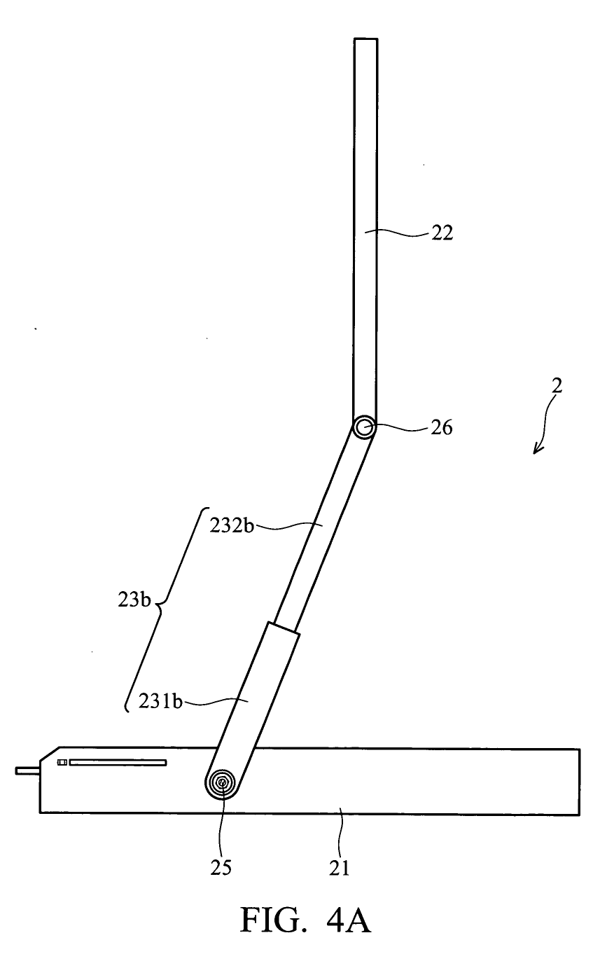

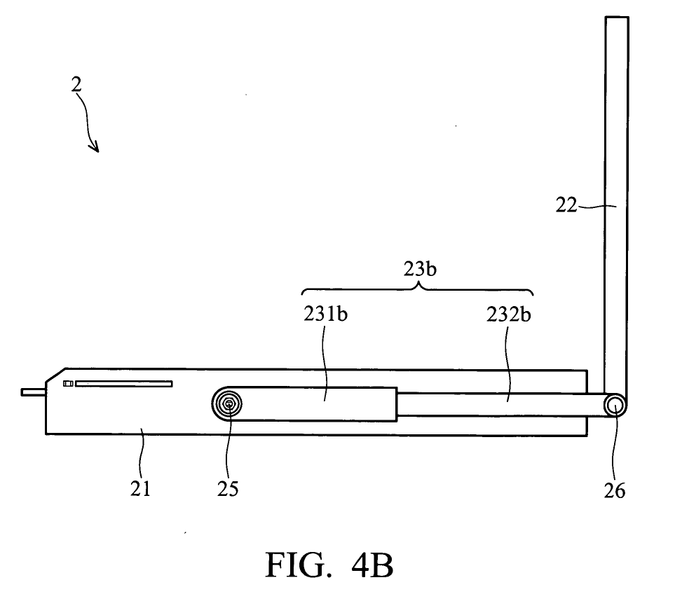

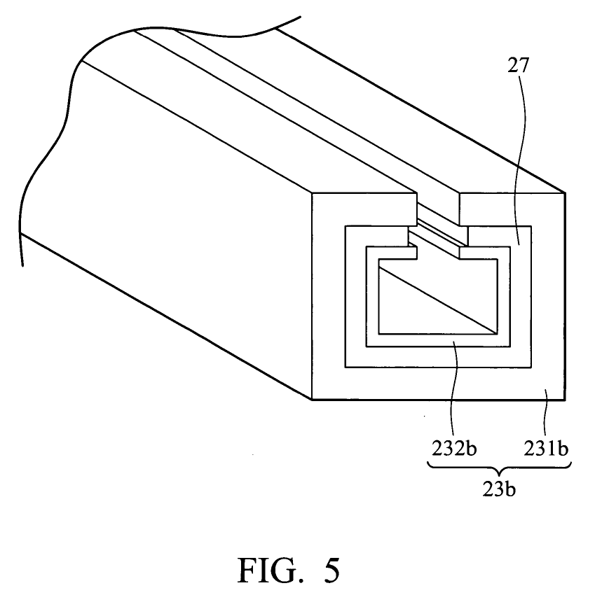

Referring to FIGS. 4A, 4B and 5, the connecting device 23b installed on opposite sides of the host 21 and the monitor 22. The connecting device 23b comprises the first link 231b connecting the host 21 via the first pivoting element 25, and the second link 232b connecting the monitor 22 via the second pivoting element 26. The first link 231b is grooved and connects the second link 232b. The connecting device 23b further comprises engineering polymer 27 installed between the first link 231b and the second link 232b. When the connecting device 23b moves telescopically by the engineering polymer 27 providing friction force between the first link 231b and the second link 232b, preventing separation thereof. The connecting device 23b allows the monitor 22 to be movable upward, downward, forward and backward with respect to the host 21.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A notebook computer with an adjustable monitor, comprising:
a host;
a monitor connected electrically to the host;
a connecting device comprising one end hinging on the host and the other end hinging on the monitor such that the monitor is movable upward, downward, forward and backward with respect to the host.

2. The notebook computer as claimed in claim 1, wherein the host comprises a hollow on the connecting device.

3. The notebook computer as claimed in claim 1, wherein the connecting device is received on the sides of the host and the monitor.

4. The notebook computer as claimed in claim 1, wherein the connecting device comprises a hollow first link and a second link, which is received in the first link telescopically.

5. The notebook computer as claimed in claim 4, wherein the connecting device further comprises an engineering polymer between the first link and the second link.
